(19) United States
(12) Patent Application Publication
(10) Pub. No.: US 2003/0034134 A1
(43) Pub. Date: Feb. 20, 2003

(54) Cover strips display system for window blind assembly

(76) Inventors: Jirair Saralou, Granada Hills, CA (US); Aderineh Saralou, Granada Hills, CA (US)

Correspondence Address: Boniard I. Brown, 1500 West Covina Parkway, #113, West Covina, CA, 91790-2793, US

(21) Appl. No.: 09/932,780

(22) Filed: Aug. 20, 2001

(51) Int. Cl. E06B 3/12

(52) U.S. Cl. 160/236

(57) ABSTRACT

Cover strips for slats of a window blind assembly provide a predetermined composite display when disposed in coplanar array. Each strip is adapted to be retained on a slat. Each strip bears a segment of the composite display.

### BACKGROUND AND SUMMARY OF THE INVENTION

The present invention provides strips attachable to slats of a conventional window blind assembly to present a predetermined composite display when the slats are rotated into coplanar array. The slats are rotatable into such array by a person pulling on a cord or a member to quickly, or by surprise, present the composite display which may display such words as “Happy Birthday” or “Merry Christmas”, or present other greetings and/or present a display of balloons, cake, etc.

In the prior art, Perez Patent No. 5,303,760 provides a plurality of sleeves for disposing on a plurality of slats of a window blind assembly to change an essentially permanent display or artwork thereon. Such a system is relatively expensive, involves substantial effort and time to place sleeves over the length of the slats, and does not enable any surprise presentation of a predetermined composite display.

According to the present invention, flat strips or covers are quickly disposed on a plurality of respective slats to extend typically 2′ or more from the upper ends of the slats. The slats are quickly installed and removed, by positioning their upper end portions about upper edge portions of respective slats, or in another embodiment, by pressing one or more bodies of adhesive on reverse sides of the strips against slats to adhere them temporarily to slats. Each strip has thereon a respective segment of the predetermined composite display, which is presented when the strips are in generally coplanar array. Respective indicia are provided on respective strips to facilitate coordination thereof to provide the predetermined display. Overlapping edge portions of respective strips bear identical respective portions of segments of the predetermined composite display to avoid any gap or discontinuity in the display.

The predetermined display may be presented as a surprise to viewers by a person pulling the operating cord to rotate the slats into coplanar array.

### BRIEF DESCRIPTION OF THE DRAWINGS

FIG. 1 is an elevational view of a window blind assembly with a plurality of slats thereof bearing strips according to the invention bearing segments of a predetermined display;

FIG. 2 is a perspective view of a strip according to the invention having an upper bent portion for retention on a slat;

FIG. 3 is a fragmentary view of a portion of FIG. 1 showing rotated mounted slats with strips of the invention thereon;

FIG. 4 is a sectional view taken at line 4-4 in FIG. 3;

FIG. 5 is an exploded perspective view of the upper portions of two adjacent strips overlapping edge portions bearing identical display portions;

FIG. 6 is a partial perspective view of a slat in relation to a rotor element 14 of a window blind assembly; and

FIG. 7 is a sectional view, similar to that of FIG. 4, showing adhesive attachment of a strip to a slat in a modified embodiment.

### DESCRIPTION OF THE PREFERRED EMBODIMENT

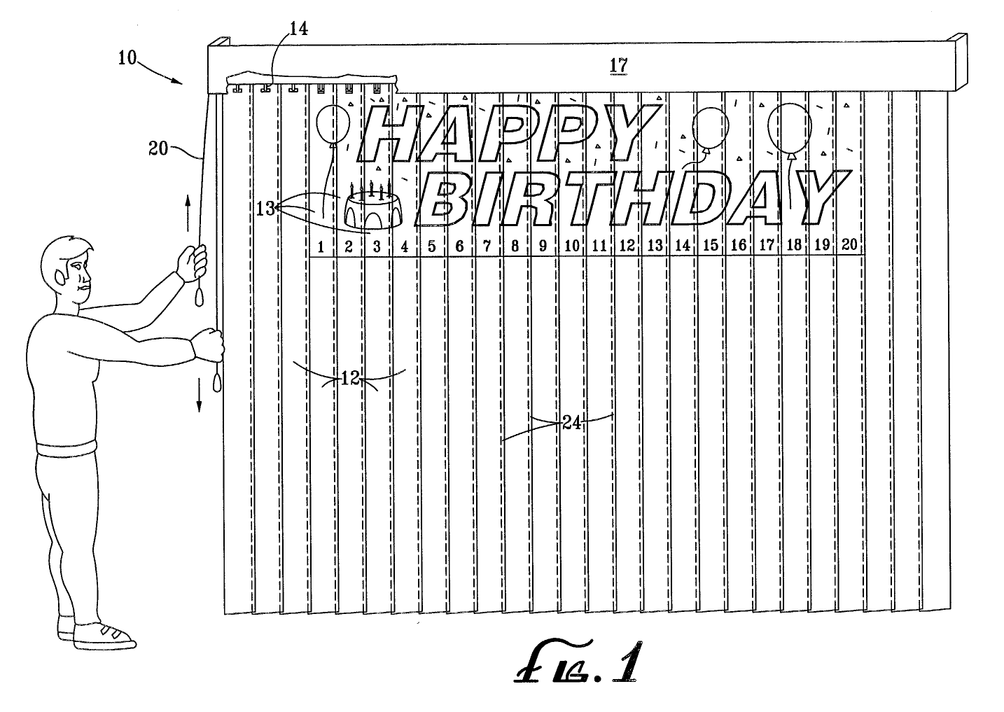

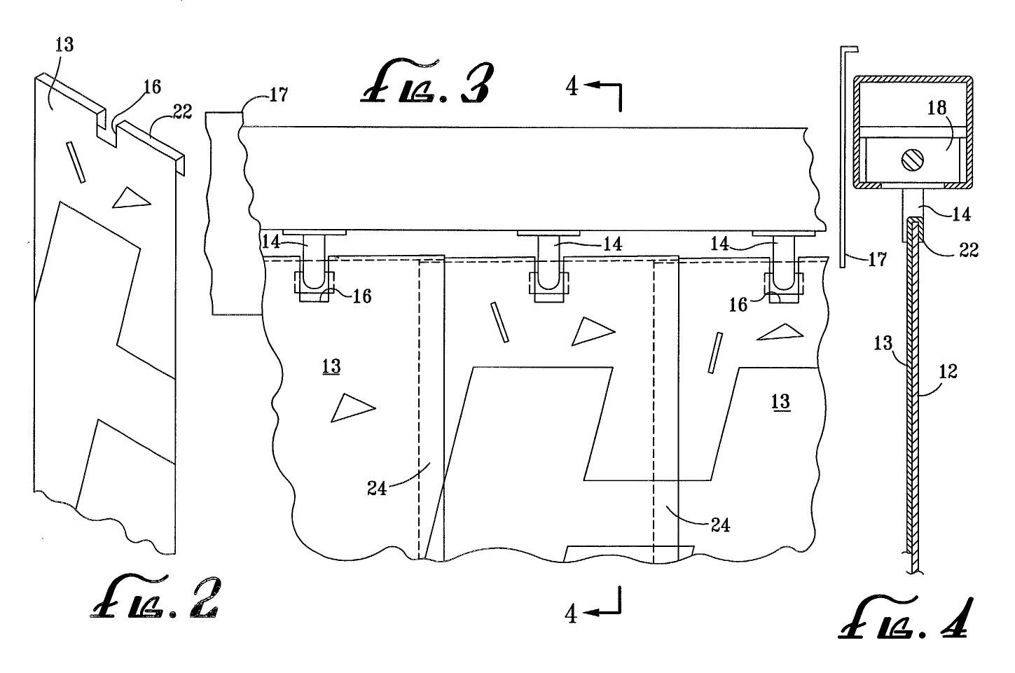

Referring to the drawings, a conventional window blind assembly 10, with a system of the invention therein, is generally shown in FIG. 1, as comprising a plurality of slats 12, each of which is pivotally mounted at its upper end portion by a rotatable pivotal element 14, as indicated in FIGS. 3 and 6. The rotatable pivot elements 14 and operating component housing 18 are covered by a header cover panel 17, as shown. Window blind assemblies are commercially available, and generally have an upper assembly mechanism for rotation of a plurality of slats in concert between an open configuration wherein the slats are in generally parallel relation, and a closed configuration wherein the slats are generally in coplanar array, and present a composite surface. With slats of relatively light weight material, interconnection is conventionally provided between lower end portions of the slats so that the lower end portions of the slats will follow movement of the upper portions. With slats of relatively stiff material, such lower interconnection is not ordinarily necessary.

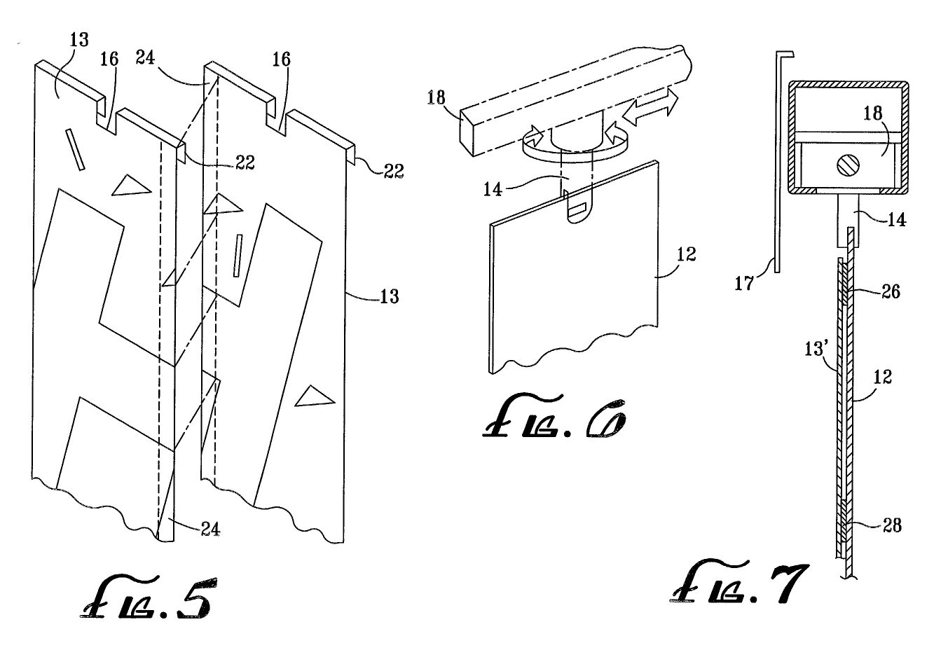

Each strip 13 has a notch 16 (FIGS. 3 and 5) in its upper end portion to accommodate pivotal element 14. The pivotal mounting of a slat 12 for rotation by pivot element 14, is shown in FIG. 6.

The stripst are typically 2′ long and extend over the upper portions of a plurality of slats (FIG. 1). Each strip has thereon a respective segment of the predetermined composite display presented by the plurality of strips. Respective strips bear respective indicia to facilitate coordination of the strips to provide the predetermined display with the slats in generally coplanar array, as indicated by numerals 1 to 20 (FIG. 1).

Each strip 13 is about the same width as the slat on which it is retained, and may typically be about 3½ wide and 2′ long. About ½ of the edge portion of each strip overlaps the adjacent strip by about ½, which is the amount by which adjacent slats overlap. The adjacent strips thus have overlapping edge portions when the slats are in generally coplanar array. The overlapping portions of respective strips bear identical respective portions of respective segments of the predetermined composite display. This prevents any gap or discontinuity in the overall predetermined display.

In a preferred embodiment, each strip has an upper bent or folded portion 22 (FIGS. 2 and 5). The suspension of the strip on a slat by engagement of the upper bent portion 22 about the upper portion of a slat, suspends and retains the strip on the slat.

In an alternative arrangement, indicated in FIG. 7, respective strips 13′ each have a body of adhesive 26 on their upper portions and a body of adhesive 28 on their lower portions. Pressing of these against a slat adheres the strip to the slat.

To rotate the slats 12 from their open configuration wherein they are in parallel array into a closed configuration wherein the slats are in generally coplanar array to display the predetermined composite display, an operator pulls on a conventional cord 20, as indicated in FIG. 1.

It will be understood that various changes and modifications may be made from the preferred embodiment discussed above without departing from the scope of the present invention, which is established by the following claims and equivalents thereof.

The inventors claim:

1. A cover strips system for slats of a pre-existing window blind assembly to provide a predetermined composite display, said system comprising:
a plurality of strips for placement on a plurality of respective slats of the window blind assembly,
each of said strips having an upper portion adapted to engage an upper portion of a slat to retain the strip on the slat, and
each of said strips having thereon a respective segment of the predetermined composite display when the strips are in generally coplanar array.

2. A cover strips system according to claim 1, wherein said slats are rotatable into generally coplanar array thereof by a mechanism of the pre-existing window blind assembly.

3. A cover strips system according to claim 1, wherein:
each of a plurality of the strips has a bent upper portion to engage about an upper portion of a slat to retain the strip on the slat.

4. A cover strips system according to claim 1, wherein:
each of a plurality of the strips has an adhesive material on its upper portion to retain the strip on the slat.

5. A cover strips system according to claim 1, wherein:
respective strips bear respective indicia to facilitate coordination of the strips to provide a predetermined display when the slats are in generally coplanar array.

6. A cover strips system according to claim 1, wherein:
respective strips have about the same width as the slats on which they are retained,
adjacent strips have overlapping edge portions when said slats are in generally coplanar array, and
overlapping edge portions of respective strips bear identical respective portions of respective segments of said predetermined composite display, whereby the predetermined display is complete without gap or discontinuity.

7. A cover strips system according to claim 2, wherein:
respective strips have about the same width as the slats on which they are retained,
adjacent strips have overlapping edge portions when said slats are in generally coplanar array, and
overlapping edge portions of respective strips bear identical respective portions of respective segments of said predetermined composite display, whereby the predetermined display is complete without gap or discontinuity.

8. A cover strips system according to claim 3, wherein:
respective strips have about the same width as the slats on which they are retained,
adjacent strips have overlapping edge portions when said slats are in generally coplanar array, and
overlapping edge portions of respective strips bear identical respective portions of respective segments of said predetermined composite display, whereby the predetermined display is complete without gap or discontinuity.

9. A cover strips system according to claim 4, wherein:
respective strips have about the same width as the slats on which they are retained,
adjacent strips have overlapping edge portions when said slats are in generally coplanar array, and
overlapping edge portions of respective strips bear identical respectice portions of respective segments of said predetermined composite display, whereby the predetermined display is complete without gap or discontinuity.

10. A cover strips system according to claim 1, wherein:
said strips are frmed of one of (a) plastic material, (b) cardboard material, (c) fabric material.

11. A cover strips system according to claim 3, wherein:
said strips are formed of one of (a) plastic material, (b) cardboard material, (c) fabric material.

12. A cover strips system according to claim 4, wherein:
said strips are formed of one of (a) plastic material, (b) cardboard material, (c) fabric material.

13. A cover strips assembly for slats of a pre-existing window blind assembly to provide a predetermined composite display, said system comprising:
a plurality of strips for placement on a plurality of respective slats of the window blind assembly,
each of said strips having thereon a respective segment of the predetermined composite display when the strips are in generally coplanar array,
each of said strips having a bent upper portion to engage about an upper portion of a slat to retain the strip on the slat,
said slats being rotatable by a mechanism of the pre-existing window blind assembly between an open array wherein slats are in generally parallel relation and a closed array wherein the slats are in a generally coplanar array wherein they present the predetermined composite display, and
each of the strips having a notch in its upper end portion to accommodate a pivotal element of said mechanism.

14. A cover strips system according to claim 13, wherein respective strips bear respective indicia to facilitate coordination of the strips to present the predetermined display with the slats in generally coplanar array.

15. A cover strips system according to claim 13, wherein:
respective strips have about the same width as the slats on which they are retained,
adjacent strips have overlapping edge portions when said slats are in generally coplanar array, and
overlapping edge portions of respective strips bear identical respective portions of respective segments of said predetermined composite display, whereby the predetermined display is complete without gap or discontinuity.

16. A cover strips system according to claim 13, wherein said strips are formed of (a) plastic material, (b) cardboard material, (c) fabric material.

17. A method of providing a predetermined composite display on a plurality of slats of a window blind assembly, comprising:
providing respective segments of the predetermined composite display on respective strips,
attaching respective strips in predetermined order on said respective ones of said plurality of slats,
providing a window blind assembly wherein said slats are rotatably mounted, and
rotating said slats into generally coplanar array to present the predetermined composite display as a surprise to viewers.

18. A method according to claim 17, and further comprising:
providing respective indicia on respective strips to facilitate a coordinated array thereof to provide the predetermined composite display.
